(19) United States
(12) Patent Application Publication
(10) Pub. No.: US 2026/0202801 A1
(43) Pub. Date: Jul. 16, 2026

(54) STOP DEVICE, STOP SYSTEM, AND METHOD FOR INSTALLING SOUND DETECTOR

(71) Applicant: Mitsubishi Electric Corporation, Tokyo (JP)

(72) Inventors: Haruka SUZUKI, Tokyo (JP); Masayuki KAKIO, Tokyo (JP); Katsuyuki SUMIMOTO, Tokyo (JP)

(73) Assignee: Mitsubishi Electric Corporation, Tokyo (JP)

(21) Appl. No.: 19/135,384

(22) PCT Filed: Feb. 15, 2023
(86) PCT No.: PCT/JP2023/005144

§ 371 Date: Jun. 4, 2025

(51) Int. Cl. G05B 9/02; G01H 3/06; G01H 3/12; G05D 13/62; G06F 3/16

(52) U.S. Cl. CPC G05B 9/02; G01H 3/06; G01H 3/12; G05D 13/62; G06F 3/16

(57) ABSTRACT

The technology disclosed in this DESCRIPTION relates to a technology for appropriately managing a means of stopping a drive unit. A stop device on the technology disclosed in this DESCRIPTION includes: a sound determining unit to determine whether a sound detected by a sound detector that detects an ambient sound includes a predetermined vibratory sound of a body of a drive unit; and a controller to stop the drive unit when the sound determining unit determines that the sound includes the predetermined vibratory sound of the body of the drive unit.

### TECHNICAL FIELD

The technology disclosed in this DESCRIPTION relates to a technology for stopping a drive unit.

### BACKGROUND ART

The rapid proliferation of self-moving robots (mobile robots) requires a technology that enables people to be safely involved with the robots.

The general means of allowing a person to stop a robot when the robot behaves unsafely is to press an emergency stop button mounted on the robot in advance. Since the emergency stop button is installed at a specific location of the robot, the person is not immediately aware of the location in some cases.

Thus, for example, Patent Document 1 discloses a technology that allows a robot to stop the robot by detecting a predetermined operation of the robot, besides pressing an emergency stop button.

Patent Document 1 discloses a sensor that detects a load or a pressure as a sensor for detecting a predetermined operation. The sensor has a problem with a limited detectable range, and, moreover, can be installed only at a specific location due to constraints in the mechanism. Thus, the predetermined operation is probably not detected at a location in which no sensor is installed.

### PRIOR ART DOCUMENT

### Patent Document

Patent Document 1: Japanese Patent Application Laid-Open No. 2004-258967

### SUMMARY

### Problem to Be Solved by the Invention

As described above, for example, the technology described in Patent Document 1 sometimes does not enable a means of stopping a drive unit of, for example, a robot except pressing an emergency stop button to fully function.

The technology disclosed in this DESCRIPTION has been conceived in view of the aforementioned problem, and is a technology for making a means of stopping a drive unit appropriately function.

### Means to Solve the Problem

A stop device on the technology disclosed in this DESCRIPTION includes: a sound determining unit to determine whether a sound detected by a sound detector that detects an ambient sound includes a predetermined vibratory sound of a body of a drive unit; and a controller to stop the drive unit when the sound determining unit determines that the sound includes the predetermined vibratory sound of the body of the drive unit.

### Effects Of The Invention

At least a first aspect of the technology disclosed in the DESCRIPTION enables the means of stopping the drive unit to appropriately function.

The object, features, aspects, and advantages of the technology disclosed in the DESCRIPTION will become more apparent from the following detailed description and the accompanying drawings.

### BRIEF DESCRIPTION OF DRAWINGS

FIG. 1 is a diagram illustrating an example configuration of a stop system according to an embodiment.

FIG. 2 is a diagram illustrating example sounds detected by a sound detector when a drive unit is a robot and a person continuously hits a body of the drive unit.

FIG. 3 is a diagram illustrating example time waveforms obtained by band-limiting, through a BPF process, the sounds detected by the sound detector when the drive unit is the robot and the person continuously hits the drive unit.

FIG. 4 is a diagram illustrating example time waveforms obtained by band-limiting, through the BPF process, the sounds detected by the sound detector when the drive unit is the robot and the person continuously hits the drive unit.

FIG. 5 is a diagram illustrating example time waveforms obtained by band-limiting, through the BPF process, the sounds detected by the sound detector when the drive unit is the robot and the person continuously hits the drive unit.

FIG. 6 is a flowchart illustrating example operations of a stop device according to an embodiment.

FIG. 7 is a diagram illustrating an example configuration of a stop system according to an embodiment.

FIG. 8 is a diagram illustrating an example configuration of a stop system according to an embodiment.

FIG. 9 is a diagram schematically exemplifying a hardware configuration when the stop device exemplified in FIGS. 1, 7, and 8 is actually operated.

FIG. 10 is a diagram schematically exemplifying a hardware configuration when the stop device exemplified in FIGS. 1, 7, and 8 is actually operated.

### DESCRIPTION OF EMBODIMENTS

Embodiments will be described below with reference to the attached drawings. Although Embodiments below will describe detailed features for description of the technology, they are mere exemplification and are not necessarily essential features for making Embodiments feasible.

The drawings are drawn in schematic form, and configurations are appropriately omitted or simplified in the drawings for convenience in description. Furthermore, the mutual relationships in size and position between images in the different drawings are not necessarily accurate but may be appropriately changed. The drawings such as plan views except cross-sectional views are sometimes hatched for facilitating the understanding of the details of Embodiments.

In the following description, the same reference numerals are assigned to the same constituent elements, and their names and functions are the same. Therefore, detailed description of such constituent elements may be omitted to avoid redundant description.

Unless otherwise specified, an expression “comprising”, “including”, or “having” a certain constituent element is not an exclusive expression for excluding the presence of the other constituent elements in this DESCRIPTION.

Even when the ordinal numbers such as “first” and “second” are used in this DESCRIPTION, these terms are used for convenience to facilitate the understanding of the details of Embodiments. The order indicated by these ordinal numbers does not restrict the details of Embodiments.

### Embodiment 1

A stop device, a stop system, and a method for installing a sound detector according to Embodiment 1 will be described hereinafter.

### Configuration of Stop System

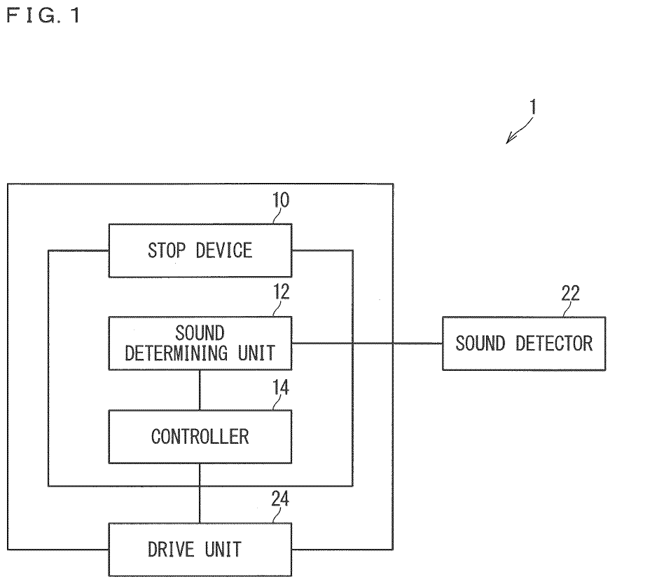

FIG. 1 is a diagram illustrating an example configuration of the stop system according to Embodiment 1. As illustrated in the example of FIG. 1, a stop system 1 includes a stop device 10, a sound detector 22, and a drive unit 24, The stop device 10 includes a sound determining unit 12 and a controller 14.

The sound determining unit 12 determines whether sounds detected by the sound detector 22 (e.g., a microphone) that detects ambient sounds include a predetermined vibratory sound of a body of the drive unit 24. Here, the drive unit 24 is, for example, a robot (e.g., a transportation robot or a security robot) or a machine tool.

When the sound determining unit 12 determines that the sounds detected by the sound detector 22 include the predetermined vibratory sound of the body of the drive unit 24, the controller 14 controls the drive unit 24 such that the drive unit 24 is stopped.

Here, when the drive unit 24 behaves unsafely (for example, when a robot exhibits a behavior such as bumping into a person), consider a scene in which the person stops the drive unit 24 by hitting the body of the drive unit 24.

The sound detector 22 detects the sound made by hitting the body of the drive unit 24 by the person. The sound determining unit 12 obtains the detected sound as time waveforms. Then, the sound determining unit 12 generates time waveforms of a sound limited to a preset frequency band, based on the time waveforms of the detected sound.

Furthermore, the sound determining unit 12 determines whether the time waveforms of the sound limited to a specific frequency band (i.e., the volume of the sound limited to the specific frequency band) are higher than or equal to a preset threshold. Here, limiting the sound to the preset frequency band is to perform a band-pass filter (i.e., BPF) process on the sound detected by the sound detector 22 in a frequency region. The process of limiting the sound to the preset frequency band is not limited to the BPF but may be, for example, a low-pass filter (i.e., LPF). Since noise levels at frequencies of the commercial power (50 Hz, 60 Hz) and fluorescent lamps are high, a notch filter process may be performed to reduce the noise levels at the frequencies. When it is expected that there is no sound (disturbance) except the sound originally desirably detected around an operation range of the drive unit 24 (here, the sound made by hitting the body of the drive unit 24 by the person), no process needs to be performed on the sound detected by the sound detector 22.

In the BPF process, the frequencies near a natural vibration frequency band of the body of the drive unit 24 are desirably set to cutoff frequencies in the BPF. This is because the natural vibration frequency band is a frequency band in which the sound generated when the person hits the body of the drive unit 24 is the largest. For example, when the drive unit 24 is a robot, since raw materials of robot bodies are often resins, the natural vibration frequency band of the drive unit 24 ranges from several tens of Hz to several hundreds of Hz, depending on the shape.

Here, although it is assumed herein that a person hits the body of the drive unit 24, an object may be thrown to the drive unit 24 or the drive unit 24 itself may collide with an obstacle. In either case, the drive unit 24 can be stopped by the sound generated when an impact is given to the body of the drive unit 24. When an unexpected unsafe situation is likely to occur, the unsafe situation can be intuitively avoided.

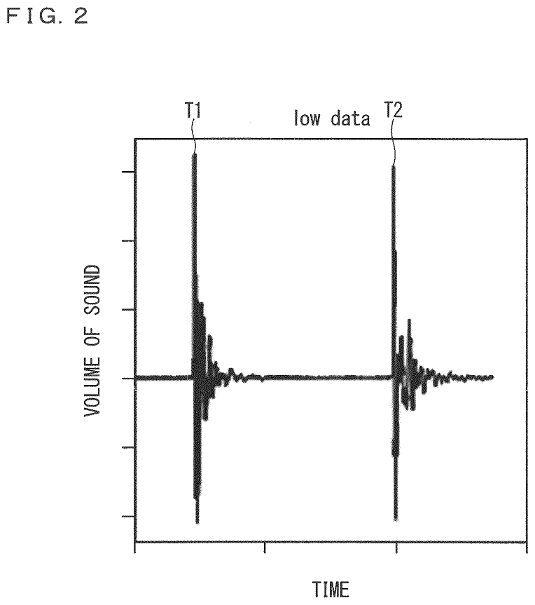

FIG. 2 is a diagram illustrating example sounds detected by the sound detector 22 when the drive unit 24 is a robot and a person continuously hits the body of the drive unit 24. In the case of FIG. 2, the person hits the body of the drive unit 24 at a timing T1 and a timing T2. In FIG. 2, the vertical axis represents the volume of the sound, and the horizontal axis represents the time.

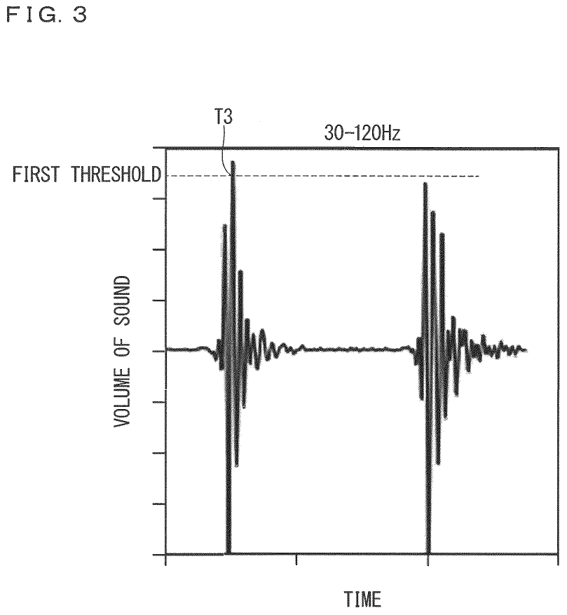

FIGS. 3, 4, and 5 are diagrams illustrating example time waveforms obtained by band-limiting, through the BPF process, the sounds detected by the sound detector 22 when the drive unit 24 is a robot and the person continuously hits the drive unit 24, In FIGS. 3, 4, and 5, the time waveforms in FIG. 2 are band-limited through the BPF process.

Hereinafter, operations of the sound determining unit 12 will be described with reference to FIGS. 3, 4, and 5.

In FIG. 3, the sound determining unit 12 determines whether the volume of the sound limited to a specific frequency band is higher than or equal to a preset first threshold, In the case of FIG. 3, the volume of the sound at a timing T3 is higher than or equal to the first threshold. Thus, the sound determining unit 12 determines that the sound includes a predetermined vibratory sound of the body of the drive unit 24 at the timing T3. Then, the controller 14 stops the drive unit 24 at the timing T1 in FIG. 2 which corresponds to the timing T3 in FIG. 3. This produces an advantage of enabling determination of an immediate stop when a very large sound normally unexpected is detected. Thus, focusing attention on a specific frequency band enables a determination operation without requiring, for example, a fast Fourier transform (i.e., FFT) analysis.

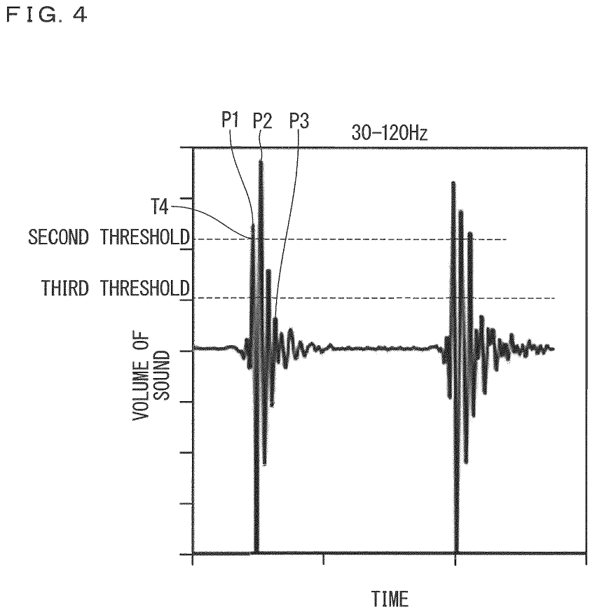

In FIG. 4, the sound determining unit 12 determines whether a time difference between a predetermined timing (a start point timing) after the volume of the sound limited to the preset frequency band is higher than or equal to a preset second threshold and a predetermined timing (an end point timing) after the peak value becomes smaller than a third threshold after the start point timing is smaller than or equal to a predefined time width (an attenuation threshold). Here, the second threshold is a value smaller than the first threshold, and the third threshold is a value smaller than the second threshold.

The predetermined timing after the volume of the sound is higher than or equal to the second threshold may be a timing at which the volume of the sound has become higher than or equal to the second threshold, or a timing at which the volume of the sound has the maximum value after becoming higher than or equal to the second threshold. Furthermore, the predetermined timing after the volume of the sound is lower than the third threshold may be a timing at which the volume of the sound has become smaller than the third threshold.

A mere comparison between the volume of the sound and its threshold as illustrated in FIG. 3 may unnecessarily stop the drive unit 24 due to a disturbance (i.e., a sound irrelevant to the sound to be detected to stop the drive unit 24). In addition, even a sound generated when the drive unit 24 normally operates may unnecessarily stop the drive unit 24.

Thus, attention was given to a larger attenuation factor of a sound made by hitting a resin to be used as a raw material of a robot body as illustrated in FIG. 4.

The following will describe a specific determination method. Since the volume of the sound is higher than or equal to the second threshold at a timing T4 in FIG. 4, the sound determining unit 12 calculates a start point timing after the timing T4 (e.g., a timing at which the peak value becomes P1). The sound determining unit 12 may determine that P1 is influenced by noise because P2 that is a peak value is larger than P1. Here, the sound determining unit 12 can calculate the timing at which the peak value becomes P2 as the start point timing after the timing T4.

Then, the sound determining unit 12 calculates the end point timing after the peak value is smaller than the third threshold after the start point timing (e.g., a timing at which the peak value becomes P3).

Then, the sound determining unit 12 determines whether a time difference between the two timings is smaller than or equal to the attenuation threshold.

In FIG. 4, the determination result is YES (less than or equal to the attenuation threshold). Here, the sound determining unit 12 determines that the sounds include the predetermined vibratory sound of the body of the drive unit 24 at the end point timing. Then, the controller 14 controls the drive unit 24 such that the drive unit 24 is stopped at the timing at which the peak value of the vibratory sound becomes P3.

As such, the method illustrated in FIG. 4 facilitates distinguishing between the sound to be detected and the sound generated when the drive unit 24 normally operates or a disturbance. This can suppress unnecessary stop of the drive unit 24.

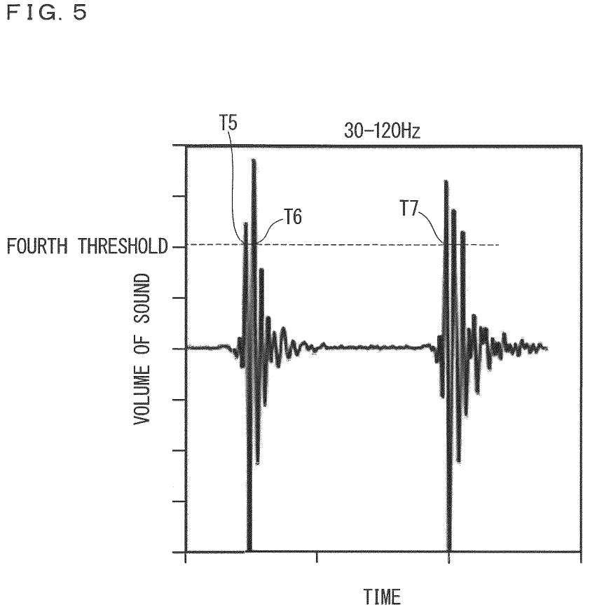

In FIG. 5, the sound determining unit 12 determines whether a time difference between a predetermined timing (a start point timing) after the volume of the sound limited to a preset frequency band is higher than or equal to a preset fourth threshold and a predetermined timing (an end point timing) after the volume of the sound is higher than or equal to the fourth threshold after the start point timing is larger than or equal to a predefined time width (an interval threshold).

It is assumed in FIG. 5 that a person hits a robot a plurality of times. For example, the opening or closing sound of a shutter (for opening or closing a storage space in which an object is stored) is continuously generated for a short period of time. In contrast, when a robot is hit a plurality of times, sounds are continuously generated for a period of time longer than that of the opening or closing sound of the shutter. Here, the sound irrelevant to the sound to be detected to stop the drive unit 24 (e.g., the opening or closing sound of the shutter) is omitted using the interval threshold.

The following will describe a specific determination method. The sound determining unit 12 determines whether a time difference between a timing T5 that is a start point timing after the volume of the sound is higher than or equal to the fourth threshold and a timing T6 that is an end point timing after the volume of the sound is higher than or equal to the fourth threshold after the start point timing is larger than or equal to the interval threshold.

Here, the time difference between the timing T5 and the timing T6 is sufficiently small in the example illustrated in FIG. 5. In this case, the sound determining unit 12 determines that the time difference between the timing T5 and the timing T6 is not larger than or equal to the interval threshold.

Next, the sound determining unit 12 determines whether a time difference between the timing T6 that is a start point timing after the volume of the sound is higher than or equal to the fourth threshold and a timing T7 that is an end point timing after the volume of the sound is higher than or equal to the fourth threshold is larger than or equal to the interval threshold.

As illustrated in the example of FIG. 5, the time difference between the timing T6 and the timing T7 is sufficiently large. In this case, the sound determining unit 12 determines that the time difference between the timing T6 and the timing T7 is larger than or equal to the interval threshold. Here, the sound determining unit 12 determines that the sounds include a predetermined vibratory sound of the body of the drive unit 24 at the timing T7. Then, the controller 14 controls the drive unit 24 such that the drive unit 24 is stopped at the timing T7.

The predetermined timing after the volume of the sound is higher than or equal to the fourth threshold may be a timing at which the volume of the sound has become higher than or equal to the fourth threshold, a timing at which the volume of the sound has the maximum value after becoming higher than or equal to the fourth threshold, or a timing at which the volume of the sound has become lower than the fourth threshold after becoming higher than or equal to the fourth threshold. After a start point timing (the timing T6) after the volume of the sound is higher than or equal to the fourth threshold appears, an end point timing (the timing T7) after the volume of the sound is higher than or equal to the fourth threshold does not appear in some cases. In other words, even after appearance of the start point timing and a lapse of the interval threshold, the end point timing does not appear in some cases. Here, the sound determining unit 12 may determine that the sounds include the predetermined vibratory sound of the body of the drive unit 24 at a timing after appearance of the start point timing and a lapse of the interval threshold.

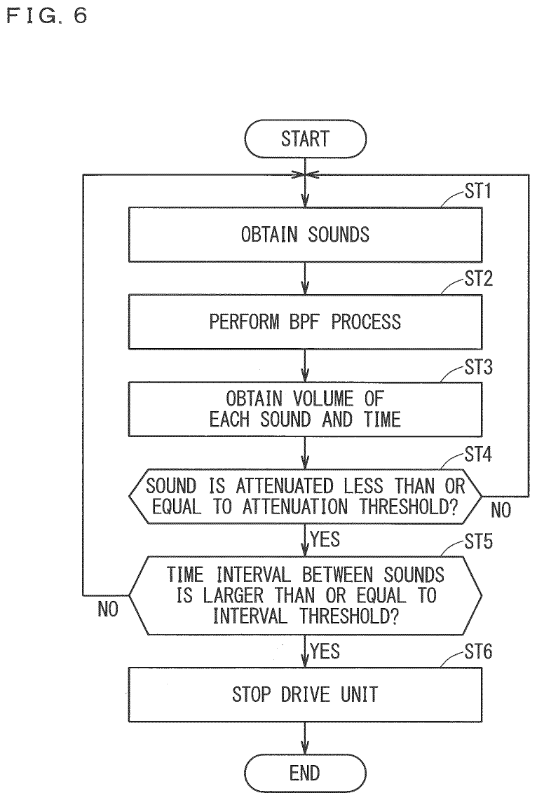

FIG. 6 is a flowchart illustrating example operations of the stop device according to Embodiment 1. The operations in FIG. 6 are operations of determining that a plurality of sounds which match threshold conditions, which are attenuated less than or equal to an attenuation threshold, and an interval of which is larger than or equal to the interval threshold include a predetermined vibratory sound of the body of the drive unit 24, and stopping the drive unit 24 based on the determination. In other words, the determination on the vibratory sound of the body of the drive unit 24 is made by a combination of the processes in FIGS. 3, 4, and 5.

First, in Step ST1, the sound determining unit 12 obtains the sounds detected by the sound detector 22. Next, in Step ST2, the BPF process is performed on each of the obtained sounds in a frequency region. Here, the sounds are limited to a frequency band of 30 Hz or higher and 120 Hz or lower, which is assumed from frequencies of natural vibrations of plastics.

Next, in Step ST3, the sound determining unit 12 determines whether the volume of the sound matches predetermined conditions when compared to preset thresholds (the first, second, third, and fourth thresholds). When matching the conditions, the sound determining unit 12 obtains the volume (a sound pressure peak value) of each of the sounds and its time, When the process in FIG. 3 is performed, the drive unit 24 can be controlled at this time such that the drive unit 24 is stopped, based on the volume of the sound obtained as being higher than or equal to the first threshold and its time. When the process in FIG. 4 is performed, the sound determining unit 12 obtains volumes and times of a sound at the start point timing which is higher than or equal to the second threshold and a sound at the end point timing which is lower than the third threshold. When the process in FIG. 5 is performed, the sound determining unit 12 obtains volumes and times of a sound at the start point timing which is higher than or equal to the fourth threshold and a sound at the end point timing which is higher than or equal to the fourth threshold after the start point timing.

Next, in Step ST4, the sound determining unit 12 determines whether the sound is attenuated less than or equal to an attenuation threshold. Specifically, when the process in FIG. 4 is performed, the sound determining unit 12 determines whether a timing difference between the sound at the start point timing which is higher than or equal to the second threshold and the sound at the end point timing which is lower than the third threshold is smaller than or equal to the attenuation threshold. Then, when the timing difference is smaller than or equal to the attenuation threshold, that is, when “YES” branching from Step ST4 exemplified in FIG. 6 is taken, the processes proceed to Step ST5 exemplified in FIG. 6. When the timing difference is not smaller than or equal to the attenuation threshold, that is, when “NO” branching from Step ST4 exemplified in FIG. 6 is taken, the processes return to Step STI exemplified in FIG. 6.

Next, in Step ST5, the sound determining unit 12 determines whether a time interval between the sounds is larger than or equal to the interval threshold. Specifically, when the process in FIG. 5 is performed, the sound determining unit 12 determines whether a timing difference between the sound at the start point timing which is higher than or equal to the fourth threshold and the sound at the end point timing which is higher than or equal to the fourth threshold after the start point timing is larger than or equal to the interval threshold. Then, when the timing difference is larger than or equal to the interval threshold, that is, when “YES” branching from Step ST5 exemplified in FIG. 6 is taken, the processes proceed to Step ST6 exemplified in FIG. 6. Then, when the timing difference is not larger than or equal to the interval threshold, that is, when “NO” branching from Step ST5 exemplified in FIG. 6 is taken, the processes return to Step ST1 exemplified in FIG. 6.

Next, in Step ST6, the controller 14 controls the drive unit 24 such that the drive unit 24 is stopped, based on the determination result made by the sound determining unit 12.

The sound determining unit 12 may determine whether the sounds include a predetermined vibratory sound of the body of the drive unit 24, based on a physical model or a machine learning model, instead of Steps ST4 and ST5. Example cases using the physical model include grasping in advance waveforms of sounds made by hitting a robot through a simulation using a multimodal analysis, and determining whether waveforms of an input sound include the predetermined vibratory sound of the body of the drive unit 24, using the waveforms of the sounds as predetermined conditions. Furthermore, example cases using machine learning include performing learning using waveform data (data of time waveforms as illustrated in FIG. 2) of sounds including the predetermined vibratory sound of the body of the drive unit 24 as inputs, and outputting whether the sounds include the predetermined vibratory sound of the body of the drive unit 24, with True or False logical values using a learned model obtained through the learning.

### Embodiment 2

A stop device, a stop system, and a method for installing a sound detector according to Embodiment 2 will be described hereinafter. In the following description, the same reference numerals are assigned to the same constituent elements described in Embodiment above, and the detailed description will be appropriately omitted.

### Configuration of Stop System

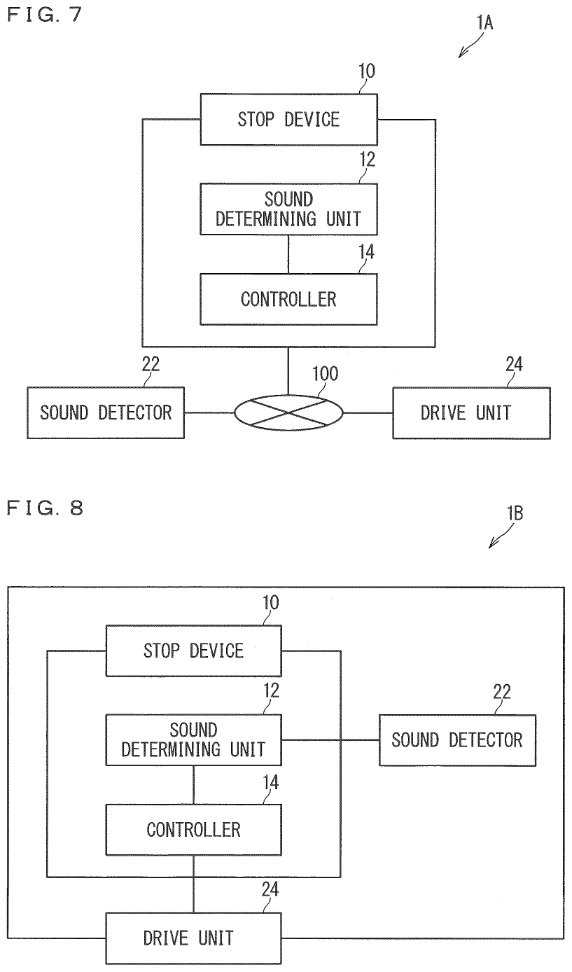

FIG. 7 is a diagram illustrating an example configuration of the stop system according to Embodiment 2. As illustrated in the example of FIG. 7, a stop system 1A includes the stop device 10, the sound detector 22, and the drive unit 24. In FIG. 7, the stop device 10, the sound detector 22, and the drive unit 24 are connected to each other through a network 100.

Such a configuration enables the stop device 10 to control, for example, the drive unit 24 which has been made by another company and whose control algorithm cannot easily be changed, such that the drive unit 24 is easily stopped.

An example conceivable case is that the drive unit 24 is a robot, and the stop device 10 and the sound detector 22 are included in a system in a building.

### Embodiment 3

A stop device, a stop system, and a method for installing a sound detector according to Embodiment 3 will be described hereinafter. In the following description, the same reference numerals are assigned to the same constituent elements described in Embodiments above, and the detailed description will be appropriately omitted.

In Embodiment 3, before determining whether the sounds include a predetermined vibratory sound of the body of the drive unit 24, the sound determining unit 12 in the stop device 10 in FIG. 1 further determines whether the sound detected by the sound detector 22 has a target waveform for which a determination is to be made to stop the drive unit 24. Then, only when the detected sound has the target waveform, the sound determining unit 12 determines whether the sound includes a predetermined vibratory sound of the body of the drive unit 24.

A method of determining whether the sound detected by the sound detector 22 has a target waveform may include using a physical model or machine learning. This can omit sounds except the target sound for which a stop determination is to be made.

Examples of the physical model include a model transfer function. Specifically, in the physical model, for example, a waveform of a sound made by hitting the drive unit 24 by a person is an input, and an ideal waveform in using a transfer function calculated in advance is an output. The sound determining unit 12 computes an output waveform using the transfer function, with the waveform of the sound detected by the sound detector 22 as an input. Then, the sound determining unit 12 determines how much this output waveform approximates the ideal output waveform. When the output waveform approximates the ideal output waveform more than a threshold, the sound determining unit 12 determines that the sound detected by the sound detector 22 has the target waveform.

When determining that the sound detected by the sound detector 22 has the target waveform, the sound determining unit 12 further determines whether the sound includes a predetermined vibratory sound of the body of the drive unit 24. When determining that the sound detected by the sound detector 22 does not have the target waveform, the sound determining unit 12 does not determine whether the sound includes a predetermined vibratory sound of the body of the drive unit 24. This enables the sound determining unit 12 to determine whether, for example, the limited sounds made by hitting the drive unit 24 by a person include a predetermined vibratory sound of the body of the drive unit 24, which can improve the determination accuracy.

### Embodiment 4

A stop device, a stop system, and a method for installing a sound detector according to Embodiment 4 will be described hereinafter. In the following description, the same reference numerals are assigned to the same constituent elements described in Embodiments above, and the detailed description will be appropriately omitted.

In Embodiment 4, the sound determining unit 12 in the stop device 10 in FIG. 1 determines whether the sounds detected by the sound detector 22 include a predetermined vibratory sound of the body of the drive unit 24, based on conditions different from those according to Embodiment 1.

Specifically, the sound determining unit 12 determines that the sounds include the predetermined vibratory sound of the body of the drive unit 24, when the detected sound has been changed (more than a threshold) in addition to any of the conditions described in Embodiment 1.

It is assumed that the drive unit 24 always generates a vibratory sound when normally operating. In this case, when a person or an object touches the drive unit 24, the drive unit 24 changes the vibratory sound. For example, the drive unit 24 changes the volume or the frequency of the vibratory sound (more than a threshold).

In such a case, the sound determining unit 12 determines that the vibratory sound generated by the drive unit 24 has been changed. Then, the controller 14 controls the drive unit 24 such that the drive unit 24 is stopped, based on the determination result. This can improve the determination accuracy, and stop the drive unit 24 not by an operation of hitting the body of the drive unit 24 but by means of a simpler operation.

### Embodiment 5

A stop device, a stop system, and a method for installing a sound detector according to Embodiment 5 will be described hereinafter. In the following description, the same reference numerals are assigned to the same constituent elements described in Embodiments above, and the detailed description will be appropriately omitted.

### Configuration of Stop System

FIG. 8 is a diagram illustrating an example configuration of the stop system according to Embodiment 5. As illustrated in the example of FIG. 8, a stop system 1B includes the stop device 10, the sound detector 22, and the drive unit 24. In FIG. 8, the sound detector 22 is disposed in the drive unit 24.

When the sound detector 22 is disposed outside the drive unit 24, the sounds detected by the sound detector 22 highly probably include unnecessary noise. In contrast, disposing the sound detector 22 in the drive unit 24 as described in Embodiment 5 can suppress detection of unnecessary noise.

### Hardware Configuration of Stop Device

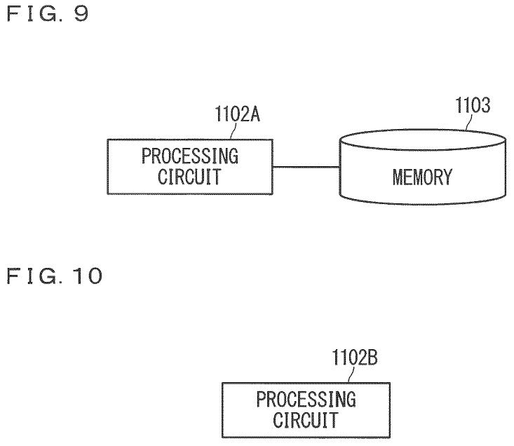

FIGS. 9 and 10 are diagrams schematically exemplifying hardware configurations when the stop device exemplified in FIGS. 1, 7, and 8 is actually operated.

The hardware configurations exemplified in FIGS. 9 and 10 do not always coincide in, for example, number with the configurations exemplified in FIGS. 1, 7, and 8. This is because the configurations exemplified in FIGS. 1, 7, and 8 illustrate conceptual units.

Thus, at least one of the following cases is conceivable: a case where one of the configurations exemplified in FIGS. 1, 7, and 8 includes a plurality of the hardware configurations exemplified in FIGS. 9 and 10; a case where one of the configurations exemplified in FIGS. 1, 7, and 8 corresponds to a part of the hardware configurations exemplified in FIGS. 9 and 10; and a case where one of the hardware configurations exemplified in FIGS. 9 and 10 includes a plurality of the configurations exemplified in FIGS. 1, 7, and 8.

FIG. 9 illustrates a processing circuit 1102A that performs computation and a memory 1103 that stores information as a hardware configuration for implementing the sound determining unit 12 and the controller 14 in FIGS. 1, 7, and 8. This configuration applies to any of Embodiments above.

FIG. 10 illustrates a processing circuit 1102B that performs computation as a hardware configuration for implementing the sound determining unit 12 and the controller 14 in FIGS. 1, 7, and 8. This configuration applies to any of Embodiments above.

Examples of the memory 1103 may include a hard disk drive (i.e., HDD), volatile or non-volatile semiconductor memories such as a random access memory (i.e., RAM), a read only memory (i.e., ROM), a flash memory, an erasable programmable read-only memory (EPROM), and an electrically erasable programmable read-only memory (EEPROM), memories (recording media) including a magnetic disc, a flexible disk, an optical disk, a compact disk, a mini disk, and a DVD, and any recording media to be used in the future.

The processing circuit 1102A may be the one that executes a program stored in, for example, the memory 1103, an external CD-ROM, an external DVD-ROM, or an external flash memory. In other words, the processing circuit 1102A may be, for example, a central processing unit (i.e., CPU), a microprocessor, a microcomputer, or a digital signal processor (i.e., DSP).

When the processing circuit 1102A is the one that executes a program stored in, for example, the memory 1103, an external CD-ROM, an external DVD-ROM, or an external flash memory, the sound determining unit 12 and the controller 14 are implemented by software, firmware, or a combination of software and firmware which causes the processing circuit 1102A to execute the program stored in the memory 1103. The functions of the sound determining unit 12 and the controller 14 may be performed by, for example, coordination of a plurality of processing circuits.

The software and the firmware may be described as programs, and stored in the memory 1103. The processing circuit 1102A performs the functions by reading and executing programs stored in the memory 1103. In other words, the program that causes the processing circuit 1102A to consequently perform the functions may be stored in the memory 1103.

Alternatively, the processing circuit 1102B may be dedicated hardware. In other words, the processing circuit 1102B may be, for example, a single circuit, a composite circuit, a programmed processor, a parallel-programmed processor, an integrated circuit (application-specific integrated circuit (i.e, ASIC)), a field-programmable gate array (FPGA), or a circuit obtained by combining these.

When the processing circuit 1102B is dedicated hardware, the sound determining unit 12 and the controller 14 are implemented by operating the processing circuit 1102B. The functions of the sound determining unit 12 and the controller 14 may be performed by separate circuits or a single circuit.

The processing circuit 1102A that executes the program stored in the memory 1103 may perform a part of the functions of the sound determining unit 12 and the controller 14. The processing circuit 1102B that is dedicated hardware may perform another part of the functions.

### Advantages Produced by Embodiments Above

Next, example advantages produced by Embodiments above will be described. While the advantages are described based on the specific configurations whose examples are described in Embodiments above, the configurations may be replaced with other specific configurations whose examples are described in this DESCRIPTION as long as the same advantages are produced. In other words, while only one of the specific configurations is sometimes described as a representative for convenience, the configuration may be replaced with another specific configuration associated with the specific configuration described as a representative.

The replacement may be performed across a plurality of Embodiments. In other words, the replacement may be performed when combinations of the configurations whose examples are described in different Embodiments produce the same advantages.

The stop device includes the sound determining unit 12 and the controller 14 according to Embodiments above. The sound determining unit 12 determines whether sounds detected by the sound detector 22 that detects ambient sounds include a predetermined vibratory sound of the body of the drive unit 24. The controller 14 stops the drive unit 24 when the sound determining unit 12 determines that the sounds include the predetermined vibratory sound of the body of the drive unit 24.

According to Embodiments above, the stop device includes the processing circuit 1102A that executes a program, and the memory 1103 in which the program to be executed is stored. The following operations are performed by causing the processing circuit 1102A to execute the program.

In other words, the drive unit 24 is stopped when the sound determining unit 12 determines that the sounds include the predetermined vibratory sound of the body of the drive unit 24.

Furthermore, the stop device includes the processing circuit 1102B that is dedicated hardware according to Embodiments above. The processing circuit 1102B that is dedicated hardware performs the following operations.

In other words, the processing circuit 1102B that is dedicated hardware stops the drive unit 24 when the sound determining unit 12 determines that the sounds include the predetermined vibratory sound of the body of the drive unit 24.

In such a configuration, when the drive unit 24 behaves unsafely, the user can stop the drive unit 24 by means of a simple operation. In other words, the means of stopping the drive unit 24 can appropriately function.

When the other configurations whose examples are described in the DESCRIPTION are appropriately added to the configuration above, that is, the other configurations in the DESCRIPTION which are not mentioned as the configuration above are appropriately added, the same advantages can be produced.

According to Embodiments above, the sound determining unit 12 determines that the sounds include the predetermined vibratory sound of the body of the drive unit 24, when the volume of the sound in a predefined frequency band is higher than or equal to the first threshold. This configuration can stop the drive unit 24 by merely determining the volume of the sound while focusing attention on the limited frequency band, without requiring, for example, the FFT analysis.

According to Embodiments above, the sound determining unit 12 determines that the sounds include the predetermined vibratory sound of the body of the drive unit 24, when a time difference between a first start point timing after the volume of the sound in a predefined frequency band is higher than or equal to a second threshold and a first end point timing after the volume of the sound is lower than a third threshold smaller than the second threshold after the first start point timing is smaller than or equal to a predefined first time width (an attenuation threshold). This configuration facilitates distinguishing between the sound to be detected and the sound generated when the drive unit 24 normally operates or a disturbance. This can suppress unnecessary stop of the drive unit 24.

According to Embodiments above, the sound determining unit 12 determines that the sounds include the predetermined vibratory sound of the body of the drive unit 24, when a time difference between a second start point timing after the volume of the sound in a predefined frequency band is higher than or equal to a fourth threshold and a second end point timing after the volume of the sound is higher than or equal to the fourth threshold after the second start point timing is larger than or equal to a predefined second time width (an attenuation threshold). This configuration facilitates distinguishing between the sound to be detected and the sound generated when the drive unit 24 normally operates or a disturbance. This can suppress unnecessary stop of the drive unit 24.

According to Embodiments above, the sound determining unit 12 determines whether the sounds in a natural vibration frequency band of the body of the drive unit 24 include the predetermined vibratory sound of the body of the drive unit 24. In such a configuration, when the drive unit 24 behaves unsafely, the user can stop the drive unit 24 by means of a simple operation.

According to Embodiments above, the sound determining unit 12 determines whether the sound has a target waveform for which a determination is to be made to stop the drive unit 24. When the sound has the target waveform, the sound determining unit 12 determines whether the sound includes the predetermined vibratory sound of the body of the drive unit 24. When the sound does not have the target waveform, the sound determining unit 12 does not determine whether the sound includes the predetermined vibratory sound of the body of the drive unit 24. This configuration can effectively omit waveforms except the target waveform for which a stop determination is to be made.

According to Embodiments above, the sound determining unit 12 determines whether the sound has the target waveform for which the determination is to be made to stop the drive unit 24, based on a physical model. This configuration can effectively omit waveforms except the target waveform for which the stop determination is to be made.

According to Embodiments above, the sound determining unit 12 determines whether the sound has the target waveform for which the determination is to be made to stop the drive unit 24, based on a machine learning model. This configuration can effectively omit waveforms except the target waveform for which the stop determination is to be made.

According to Embodiments above, the sound determining unit 12 determines whether the sound includes the predetermined vibratory sound of the body of the drive unit 24, based on a physical model. In such a configuration, when the drive unit 24 behaves unsafely, the user can stop the drive unit 24 by means of a simple operation.

According to Embodiments above, the sound determining unit 12 determines whether the sound includes the predetermined vibratory sound of the body of the drive unit 24, based on a machine learning model. In such a configuration, when the drive unit 24 behaves unsafely, the user can stop the drive unit 24 by means of a simple operation.

According to Embodiments above, the sound determining unit 12 determines that the sound includes the predetermined vibratory sound of the body of the drive unit 24, when the sound has been changed. In such a configuration, in the case where the drive unit 24 behaves unsafely, the user can stop the drive unit 24 with high accuracy by detecting changes in the vibratory sound when a person or an object touches the drive unit 24.

Embodiments above include the stop device, the sound detector 22 that detects ambient sounds, and the drive unit 24 that is driven.

In such a configuration, when the drive unit 24 behaves unsafely, the user can stop the drive unit 24 by means of a simple operation. When the stop device 10, the sound detector 22, and the drive unit 24 are connected to each other through the network 100, the stop device 10 can easily control the drive unit 24 which has been made by another company and whose control algorithm cannot easily be changed, such that the drive unit 24 is easily stopped.

According to Embodiments above, the sound detector 22 is disposed in the drive unit 24 as a method for installing a sound detector.

With such a configuration, disposing the sound detector 22 in the drive unit 24 can reduce unnecessary noise.

When there is no particular limitation, the order of the processes can be changed.

When the other configurations whose examples are described in the DESCRIPTION are appropriately added to the configuration above, that is, the other configurations in the DESCRIPTION which are not mentioned as the configuration above are appropriately added, the same advantages can be produced.

### Modifications of Embodiments Above

Although Embodiments described above sometimes specify dimensions, shapes, relative arrangement relationships, or conditions for implementation of each of the constituent elements, these are examples in all aspects and are not restrictive.

Therefore, numerous modifications and equivalents that have not yet been exemplified will be devised within the scope of the technology disclosed in the DESCRIPTION. Examples of the modifications include modifying, adding, or omitting at least one constituent element, and further extracting at least one constituent element in at least one of Embodiments and combining the extracted constituent element with a constituent element in another Embodiment.

Furthermore, when a constituent element is described as one element in Embodiments above, the number of the constituent elements may be more than one unless it is contradictory.

Furthermore, the constituent elements in Embodiments above are conceptual units. The scope of the technology disclosed in the DESCRIPTION covers one constituent element comprising a plurality of structures, one constituent element corresponding to a part of a structure, and a plurality of constituent elements included in one structure.

Furthermore, each of the constituent elements in Embodiments above includes another configuration or a structure having a shape as long as it fulfills the same function.

The DESCRIPTION is referred to for all the objectives relevant to the present technology, and is not regarded as prior art.

Furthermore, each of the constituent elements in Embodiments above is assumed as software or firmware, or hardware corresponding to the software or the firmware, is referred to as, for example, a part as software, and is referred to as circuitry as hardware,

### EXPLANATION OF REFERENCE SIGNS

1 stop system, 1A stop system, 1B stop system, 10 stop device, 12 sound determining unit, 14 controller, 22 sound detector, 24 drive unit.

1. A stop device, comprising:
at least one processor to execute a program; and
at least one memory to store the program which, when it is executed by the processor, performs processes of:
determining whether a sound detected by a sound detector that detects an ambient sound includes a predetermined vibratory sound generated from vibrations made against a body of a drive unit; and
stopping the drive unit when it is determined that the sound includes the predetermined vibratory sound generated from the vibrations made against the body of the drive unit.

2. The stop device according to claim 1,
wherein the determining includes determining that the sound includes the predetermined vibratory sound generated from the vibrations made against the body of the drive unit, when a volume of the sound in a predefined frequency band is higher than or equal to a first threshold.

3. The stop device according to claim 1,
wherein the determining includes determining that the sound includes the predetermined vibratory sound generated from the vibrations made against the body of the drive unit, when a time difference between a first start point timing after a volume of the sound in a predefined frequency band is higher than or equal to a second threshold and a first end point timing after the volume of the sound is lower than a third threshold after the first start point timing is smaller than or equal to a predefined first time width, the third threshold being smaller than the second threshold.

4. The stop device according to claim 1,
wherein the determining includes determining that the sound includes the predetermined vibratory sound generated from the vibrations made against the body of the drive unit, when a time difference between a second start point timing after a volume of the sound in a predefined frequency band is higher than or equal to a fourth threshold and a second end point timing after the volume of the sound is higher than or equal to the fourth threshold after the second start point timing is larger than or equal to a predefined second time width.

5. The stop device according to any claim 1,
wherein the determining includes determining whether the sound in a natural vibration frequency band of the body of the drive unit includes the predetermined vibratory sound generated from the vibrations made against the body of the drive unit.

6. The stop device according to claim 1,
wherein the determining includes determining whether the sound has a target waveform for which a determination is to be made to stop the drive unit,
when the sound has the target waveform, it is determined whether the sound includes the predetermined vibratory sound generated from the vibrations made against the body of the drive unit, and
when the sound does not have the target waveform, it is not determined whether the sound includes the predetermined vibratory sound generated from the vibrations made against the body of the drive unit.

7. The stop device according to claim 6,
wherein the determining includes determining whether the sound has the target waveform for which the determination is to be made to stop the drive unit, based on a physical model.

8. The stop device according to claim 6,
wherein the determining includes determining whether the sound has the target waveform for which the determination is to be made to stop the drive unit, based on a machine learning model.

9. The stop device according to claim 1,
wherein the determining includes determining whether the sound includes the predetermined vibratory sound generated from the vibrations made against the body of the drive unit, based on a physical model.

10. The stop device according to claim 1,
wherein the determining includes determining whether the sound includes the predetermined vibratory sound generated from the vibrations made against the body of the drive unit, based on a machine learning model.

11. The stop device according to claim 1,
wherein the determining includes determining that the sound includes the predetermined vibratory sound generated from the vibrations made against the body of the drive unit, when the sound has been changed.

12. A stop system, comprising:
the stop device according to claim 1;
the sound detector to detect an ambient sound; and
the drive unit to be driven.

13. A method for installing a sound detector in a stop system including:
a sound detector to detect an ambient sound;
a drive unit to be driven;
at least one processor to execute a program; and
at least one memory to store the program which, when it is executed by the processor, performs processes of:
determining whether the sound detected by the sound detector includes a predetermined vibratory sound generated from the vibrations made against a body of the drive unit; and
stopping the drive unit when it is determined that the sound includes the predetermined vibratory sound generated from the vibrations made against the body of the drive unit, the method comprising
disposing the sound detector in the drive unit.

14. The stop device according to claim 1,
wherein the predetermined vibratory sound generated from the vibrations made against the body of the drive unit is a sound generated when the drive unit does not normally operate.

15. The stop device according to claim 1,
wherein the determining includes determining, at a timing after a lapse of a predefined second time width from a second start point timing, that the sound includes the predetermined vibratory sound generated from the vibrations made against the body of the drive unit when a volume of the sound is not higher than or equal to a fourth threshold for the lapse of the second time width from the second start point timing, the second start point timing being a timing after the volume of the sound in a predefined frequency band is higher than or equal to the fourth threshold.
